(19) United States
(12) Patent Application Publication
(10) Pub. No.: US 2016/0018273 A1
(43) Pub. Date: Jan. 21, 2016

(54) TEMPERATURE SENSING APPLICATION FOR MOBILE DEVICE

(71) Applicant: Benjamin M. Jordan, St. Paul, MN (US)

(72) Inventor: Benjamin M. Jordan, St. Paul, MN (US)

(21) Appl. No.: 14/674,892

(22) Filed: Mar. 31, 2015

Related U.S. Application Data
(60) Provisional application No. 62/025,382, filed on Jul. 16, 2014.

(51) Int. Cl. G01K 13/00

(52) U.S. Cl. CPC G01K 13/00

(57) ABSTRACT

Aspects of the present disclosure relate to measuring an external temperature using a computing device. In one case, a model for measuring the external temperature may be derived. A solution of the model may be compared with at least one data quantity of a plurality of data quantities to determine a difference between the solution of the model and the at least one of the plurality of data quantities. One or more parameters of the model may be fit such that the difference between the solution of the model and the at least one of the plurality of data quantities is minimized. The external temperature may be measured using the solution of the model.

### CROSS-REFERENCE TO RELATED APPLICATIONS

This application claims the benefit of U.S. Provisional Patent Application No. 62/025,382, filed Jul. 16, 2014, entitled “TEMPERATURE SENSING APPLICATION FOR MOBILE DEVICE,” which application is incorporated herein by reference in its entirety.

### BACKGROUND

Generally, temperature is measured using a thermometer. Most thermometers rely on measuring some physical property of a working material that varies with temperature. For example, an electric thermometer may include a thermoresistor that changes its resistance with changes in temperature. A computer or other circuit may measure the resistance and convert it to a temperature. In this regard, in order for a person to measure the temperature, the person is required to have a temperature measuring instrument (e.g., a thermometer) with them at the time they desire to measure the temperature.

It is with respect to these and other general considerations that embodiments have been made. Also, although relatively specific problems have been discussed, it should be understood that the embodiments should not be limited to solving the specific problems identified in the background.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In embodiments, a computer-implemented method for measuring an external temperature using a computing device is provided. The method may include deriving a model for measuring the external temperature. Deriving a model for measuring the external temperature may include identifying one or more temperature compartments, identifying one or more boundaries between the one or more temperature compartments, placing the computing device into a configuration that limits a number of boundaries and temperature compartments, measuring a plurality of data quantities using at least one sensor of the computing device, and determining parameters of the model using the plurality of data quantities such that the parameters of the model are minimized. A solution of the model may be compared with at least one of the plurality of data quantities to determine a difference between the solution of the model and the at least one of the plurality of data quantities. One or more of the parameters of the model may be fit such that the difference between the solution of the model and the at least one of the plurality of data quantities is minimized. The method may further include measuring the external temperature using the solution of the model.

In further embodiments, a computer-implemented method for measuring an external temperature using a computing device includes using a model configured to measure the external temperature. A solution of the model may be derived from a calibration of the computing device. The method further includes executing the solution of the model. In embodiments, executing the solution of the model includes comparing the solution of the model with recorded temperature data, determining a difference between the solution of the model and the recorded temperature data, and fitting a parameter of the model that corresponds to the external temperature such that the difference between the solution of the model and the recorded temperature data is minimized. The method may further include measuring the external temperature using the solution of the model.

In yet further embodiments, a computer storage device having computer executable instructions that, when executed by a processor, perform a method for measuring an external temperature using a computing device. The method may include using a model configured to measure the external temperature. A solution of the model may be derived from a calibration of the computing device. The method further includes executing the solution of the model. In embodiments, executing the solution of the model includes comparing the solution of the model with recorded temperature data, determining a difference between the solution of the model and the recorded temperature data, and fitting a parameter of the model that corresponds to the external temperature such that the difference between the solution of the model and the recorded temperature data is minimized. The method may further include measuring the external temperature using the solution of the model.

These and various other features as well as advantages that characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing general description and the following detailed description are exemplary and explanatory and are intended to provide further explanation of the claims.

### BRIEF DESCRIPTION OF THE DRAWINGS

FIG. 1 illustrates embodiments of a computing device for measuring the external temperature.

FIG. 2 illustrates embodiments of a diagram of four compartments and their associated connectivity.

FIG. 3 illustrates embodiments of a first configuration for measuring the external temperature using a computing device.

FIG. 4 illustrates embodiments of a second configuration for measuring the external temperature using the computing device.

FIG. 5 illustrates embodiments of a third configuration for measuring the external temperature using the computing device.

FIG. 6 illustrates embodiments of a user interface of the computing device.

FIG. 7 is a flow diagram representing an embodiment of a method for measuring an external temperature using a computing device.

FIG. 8 is a flow diagram representing another embodiment of a method for measuring an external temperature using a computing device.

FIG. 9 illustrates a system for measuring an external temperature according to one or more embodiments.

FIG. 10 is a block diagram illustrating physical components of a computing device with which embodiments of the disclosure may be practiced.

### DETAILED DESCRIPTION

As disclosed herein, when a person desires to measure the temperature of a substance, it may be desirable to have a temperature measuring application instantly available for the person to measure the temperature. In this regard, it may be desirable to have a temperature measuring application on a mobile device that is commonly accessible to the person in most situations. For example, the mobile device may be a computing device such as a mobile phone, a smart phone, a tablet computer, a laptop, a smart watch, and the like.

Systems and methods are provided herein for measuring and/or sensing the temperature of a substance and/or material using a computing device. In one example, a substance may include any species of matter such as air, water, blood, tissue, metal, wood, plastic, mineral, and the like. In one example, a material may include a mixture of substances and/or any composition of materials. In one case, the temperature of a substance and/or material may be determined by measuring and/or calculating data received by sensors of the computing device. In this regard, a model may be derived for measuring the temperature of a substance and/or material. In some cases, the model may be based on one or more temperature compartments with a known topological connectivity and boundary area shared between the compartments. For example, the one or more compartments may represent an ambient air temperature, a device temperature, a skin temperature, and a core body temperature and their respective shared connections and boundaries. As such, the data received and measured by the sensors of the computing device may be associated with the one or more compartments and used as parameters in the model to measure the temperature of a substance and/or material.

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art.

Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

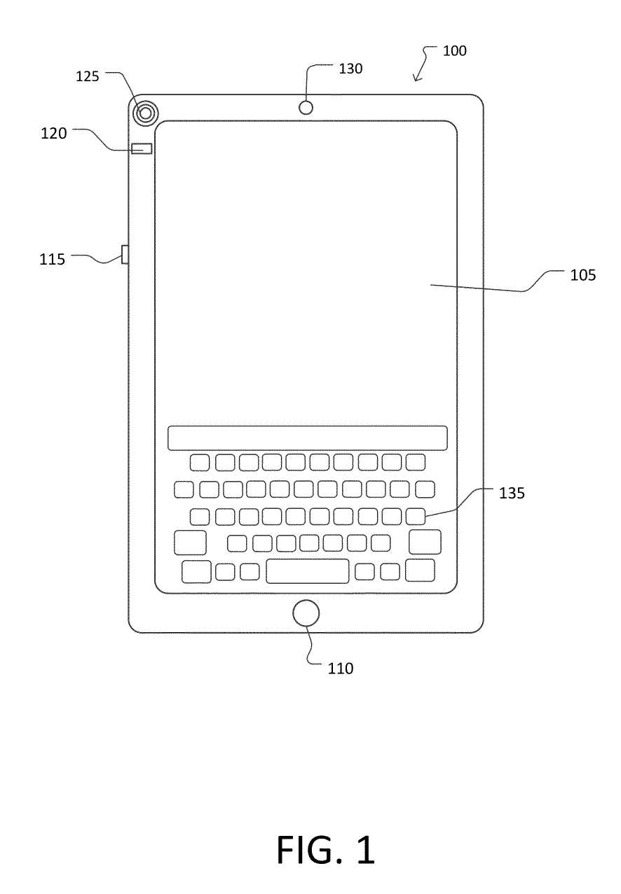

FIG. 1 illustrates a computing device 100, for measuring an external temperature, with which embodiments of the present disclosure may be practiced. The computing device 100 may be any suitable computing device for executing an application for measuring the temperature of a substance and/or material. For example, the computing device may be at least one of: a mobile telephone; a smart phone; a tablet; a smart watch; a wearable computer; a personal computer; a desktop computer; a laptop computer; a field programmable gate array (FPGA); and etc. This list is exemplary only and should not be considered as limiting. Any suitable computing device for executing the application for measuring the temperature of a substance and/or material may be utilized.

With reference to FIG. 1, one embodiment of a computing device 100 for implementing the embodiments is illustrated. In a basic configuration, the computing device 100 is a handheld computer having both input elements and output elements. The computing device 100 typically includes a display 105 (e.g., a screen) and one or more input buttons 110 that allow the user to enter information into the computing device 100. The screen 105 of the mobile computing device 100 may also function as an input device (e.g., a touch screen display). The screen 105 may be located on the front of the computing device 100. If included, an optional side input element 115 allows further user input. The side input element 115 may be a rotary switch, a button, or any other type of manual input element. The side input element 115 may be located on at least one of the sides of the mobile device 100. In alternative embodiments, computing device 100 may incorporate more or less input elements. For example, the screen 105 may not be a touch screen in some embodiments.

In yet another alternative embodiment, the computing device 100 is a portable phone system, such as a cellular phone. The computing device 100 may also include an optional keypad 135. Optional keypad 135 may be a physical keypad or a “soft” keypad generated on the touch screen display (shown). In various embodiments, the output elements include the display 105 for showing a graphical user interface (GUI), a visual indicator 120 (e.g., a light emitting diode, LED), and/or an audio transducer 125 (e.g., a speaker). In some embodiments, the computing device 100 incorporates a vibration transducer for providing the user with tactile feedback. In yet another embodiment, the computing device 100 incorporates input and/or output ports, such as an audio input (e.g., a microphone jack), an audio output (e.g., a headphone jack), and a video output (e.g., a HDMI port) for sending signals to or receiving signals from an external device.

In another embodiment, the computing device 100 may include a plurality of sensors. The plurality of sensors may be at one location in the computing device 100 and/or at various locations in the computing device 100. For example, the computing device 100 may include a plurality of battery temperature sensors. In another example, the plurality of sensors may include at least one of a linear accelerometer, an orientation sensor, a light/lumen sensor, a voltage/current sensor, a screen brightness sensor, a pressure sensor, a humidity sensor, and the like. In some cases, the screen 105 of the computing device 100 may have a calculable area. Similarly, a back portion of the computing device 100 may have a calculable area. For example, the touch screen display 105 and/or the back portion of the computing device 100 may be a two-dimensional surface that can be expressed as an area quantity. In some cases, the area of the screen 105 and the back portion of the computing device 100 are approximately equivalent. For example, the front and the back portions of the computing device 100 may be substantially the same size. In this example, the screen 105 may occupy substantially the entire front portion of the computing device 100 such that the screen 105 and the back portion of the computing device 100 have an approximately equivalent area.

As discussed above, the computing device 100 may include a front portion, a back portion, and sides. In this regard, the computing device 100 may be held in various manners. In one example, the computing device 100 may be held by placing the computing device 100 on a surface. In one example, the computing device 100 may be placed on a surface such that it rests on the surface without user interaction (e.g., placing the computing device 100 on a table). In another example, the computing device 100 may be held against a surface (e.g., a wall) by a user. In another example, the computing device 100 may held in the hand of a user. In one case, the computing device 100 may be palmed in the hand of the user. In another case, the computing device 100 may be held on its sides with the fingers of a user.

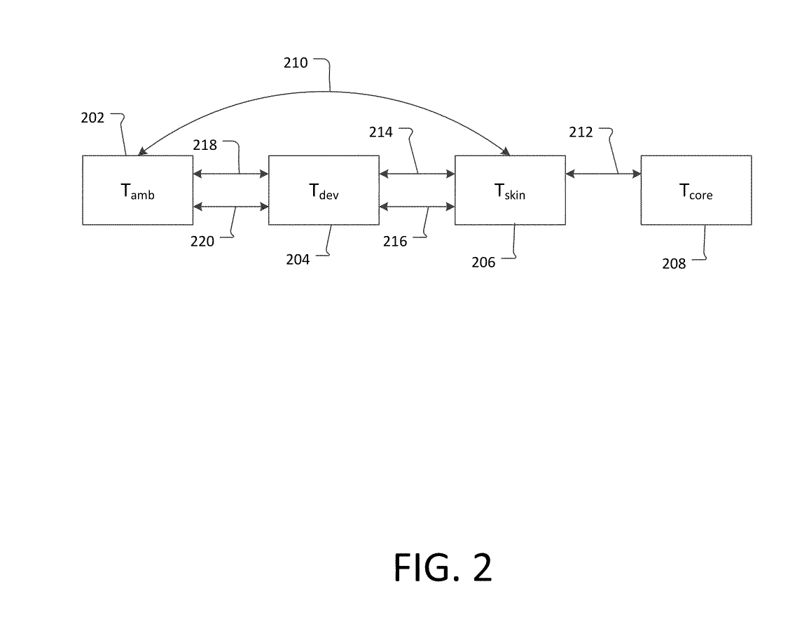

FIG. 2 illustrates embodiments of a diagram of four compartments and their associated connectivity. As discussed above, a model may be derived for measuring the temperature of a substance and/or material. In some cases, the model may be based on one or more temperature compartments with a known topological connectivity and boundary area shared between the compartments. For example, as illustrated in FIG. 2, the model may be based on four temperature compartments. The four compartments may represent ambient air temperature (T_{amb}) 202, a device temperature (T_{dev}) 204, skin temperature (Tₛₖᵢₙ) 206, and core body temperature (T_{core}) 208 and their respective shared connections and boundaries. In this regard, the model is derived based on utilizing a plurality of data quantities associated with the four compartments.

In one case, the compartment connections and boundaries that are accounted for when deriving the model include at least (1) the boundary between the ambient air temperature (T_{amb}) 202 and the skin temperature (Tₛₖᵢₙ) 206 of a person, (2) the boundary between the core body temperature (T_{core}) 208 and the skin temperature (Tₛₖᵢₙ) 206, (3) the boundary between the device temperature (T_{dev}) 204 and the skin temperature (Tₛₖᵢₙ) 206, and (4) the boundary between the ambient air temperature (T_{amb}) 202 and the device temperature (T_{dev}) 204.

The boundary between the ambient air temperature (T_{amb}) 202 and the skin temperature (Tₛₖᵢₙ) 206 of a person may include boundary 210. The boundary 210 includes the data quantities associated with the boundary between the ambient air temperature (T_{amb}) 202 and the skin temperature (Tₛₖᵢₙ) 206 of a person. The boundary between the core body temperature (T_{core}) 208 and the skin temperature (Tₛₖᵢₙ) 206 may include boundary 212. The boundary 212 includes the data quantities associated with the boundary between the core body temperature (T_{core}) 208 and the skin temperature (Tₛₖᵢₙ) 206. The boundary between the device temperature (T_{dev}) 204 and the skin temperature (Tₛₖᵢₙ) 206 may include a first boundary 214 and a second boundary 216. The first boundary 214 may include the data quantities associated with boundary between the skin temperature (Tₛₖᵢₙ) 206 and the screen 105 of the computing device 100. The second boundary 216 may include the data quantities associated with the boundary between the skin temperature (Tₛₖᵢₙ) 206 and the back portion of the computing device 100. The boundary between the ambient air temperature (T_{amb}) 202 and the device temperature (T_{dev}) 204 may include a first boundary 218 and a second boundary 220. The first boundary 218 may include the data quantities associated with the boundary between the ambient air temperature (T_{amb}) 202 and the screen 105 of the computing device 100. The second boundary 220 may include the data quantities associated with the boundary between the ambient air temperature (T_{amb}) 202 and the back portion of the computing device 100.

Accounting for the four compartments and their corresponding connections and boundaries allows one to solve for four terms using the plurality of data quantities associated with the four compartments. The four terms include the ambient air temperature (T_{amb}), the core body temperature (T_{core}), the rate of change in temperature of the computing device 100 (T_{dev}), and the rate of change in temperature of a user's skin (Tₛₖᵢₙ). The ambient air temperature (T_{amb}) and the core body temperature (T_{core}) may be measured over some period of time such that the ambient air temperature (T_{amb}) and the core body temperature (T_{core}) essentially become constants in the model. In contrast, the rate of change in temperature of the computing device 100 (T_{dev}) may vary and the rate of change in temperature of the skin of a user (Tₛₖᵢₙ) may vary. Accordingly, these terms need to be solved for.

In order to solve for the rate of change in temperature of the computing device 100 (T_{dev}), a plurality of data quantities associated with the rate of change in temperature of the computing device 100 (T_{dev}) may be evaluated. For example, a first equation representing the rate of change in temperature of the device (T_{dev}) is as follows:

$$\frac{d}{d t} {T}_{dev} ( t ) = {k}_{ambdev}^{scr} \cdot {A}_{amb}^{scr} ( {T}_{amb} - {T}_{dev} ( t ) ) + {k}_{ambdev}^{back} \cdot {A}_{amb}^{back} ( {T}_{amb} - {T}_{dev} ( t ) ) + {k}_{skindev}^{scr} \cdot {A}_{skin}^{scr} ( {T}_{skin} ( t ) - {T}_{dev} ( t ) ) + {k}_{skindev}^{back} \cdot {A}_{skin}^{back} \cdot {A}_{skin}^{back} ( {T}_{skin} ( t ) - {T}_{dev} ( t ) ) + {K}_{devcpu} + {K}_{devscr} + {K}_{devph} + {K}_{gpu} + {K}_{gps} + {K}_{wifi} + {K}_{mob}$$

The plurality of data quantities associated with the rate of change in temperature of the computing device 100 (T_{dev}) may include at least the ambient air temperature (T_{amb}), the device temperature (T_{dev}), the skin temperature (Tₛₖᵢₙ), the area of the screen 105 of the computing device 100 that is surrounded by ambient air (A_{amb}^{scr}), the rate of change in temperature between the ambient air and the screen 105 of the computing device 100 (k_{ambdev}^{scr}), the area of the back of the computing device 100 that is surrounded by ambient air (A_{amb}^{back}), the rate of change in temperature between the ambient air and the back of the computing device 100 (k_{ambdev}^{back}), the area of the screen 105 of the computing device 100 that is surrounded by the skin of a user (Aₛₖᵢₙ^{scr}), the rate of change in temperature between the skin of a user and the screen 105 of the computing device 100 (k_{skindev}^{scr}), the area of the back of the computing device 100 that is surrounded by the skin of a user (Aₛₖᵢₙ^{back}), the rate of change in temperature between the skin of a user and the back of the computing device 100 (k_{skindev}^{back}), the rate of heat produced by the CPU of the computing device 100 (K_{devcpu}), the rate of heat produced by the screen 105 of the computing device 100 (K_{devscr}), the rate of radiative heat absorbed by the computing device 100 when the computing device 100 is exposed to light (K_{devph}), the rate of heat produced by the gpu (K_{gpu}), the rate of heat produced by the gps transceiver (K_{gps}), the rate of heat produced by the wife transceiver (K_{wifi}), and the rate of heat produced by the CDMA and/or GSM transceiver (K_{mob}).

In order to solve for the rate of change in temperature of the skin of a user (Tₛₖᵢₙ), a plurality of data quantities associated with the rate of change in temperature of the skin of a user (Tₛₖᵢₙ) may be evaluated. For example, a second equation representing the rate of change in temperature of the skin of a person (Tₛₖᵢₙ) is as follows:

$$\frac{d}{d t} {T}_{skin} ( t ) = {k}_{skindev}^{scr} \cdot {A}_{skin}^{scr} ( {T}_{dev} ( t ) - {T}_{skin} ( t ) ) + {k}_{skindev}^{back} \cdot {A}_{skin}^{back} ( {T}_{dev} ( t ) - {T}_{skin} ( t ) ) + {k}_{ambskin} \cdot {A}_{skin} ( {T}_{amb} - {T}_{skin} ( t ) ) + {k}_{skincore} \cdot {A}_{skin} ( {T}_{core} - {T}_{skin} ( t ) ) + {K}_{skinph}$$

The plurality of data quantities associated with the rate of change in temperature of the skin of a user (Tₛₖᵢₙ) may include at least the ambient air temperature (T_{amb}), the core body temperature of a user (T_{core}), the device temperature (T_{dev}), the temperature of the skin of a user (Tₛₖᵢₙ), the area of the screen 105 of the computing device 100 that is surrounded by the skin of a user (Aₛₖᵢₙ^{scr}), the rate of change in temperature between the skin of a user and the screen 105 of the computing device 100 (k_{skindev}^{scr}), the area of the back of the computing device 100 that is surrounded by the skin of a user (Aₛₖᵢₙ^{back}), the rate of change in temperature between the skin of a user and the back of the computing device 100 (k_{skindev}^{back}), the area of the skin of a user that is not touching the computing device 100 (Aₛₖᵢₙ), the rate of change in temperature between the skin of a user and the ambient air (k_{skinamb}), the rate of change in temperature between the skin of a user and the core body of the user (k_{skincore}), and the rate of radiative heat absorbed by the skin of a user when the skin of the user is exposed to light (Kₛₖᵢₙₚₕ).

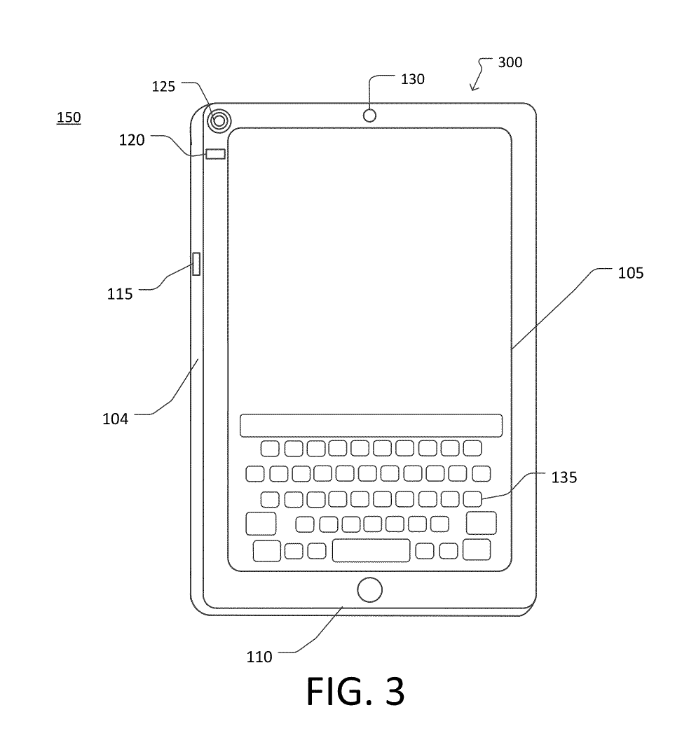

In order to reduce the above equations and determine parameters, calibration of the computing device 100 is performed under certain controlled conditions. As detailed above, the model for measuring the temperature of a substance and/or material is based on the four compartments and their corresponding connections and boundaries. By placing the device in various configurations, at least some of the terms can be solved. For example, at least a rate of change in temperature of the computing device 100 and a rate of change in temperature of the skin of a user may be determined. For example, with reference now to FIG. 3, a first configuration 300 of the model includes the computing device 100 exposed to and completely surrounded by ambient air 150. In one case, the computing device 100 may be calibrated in the first configuration 300. In this regard, a screen 105 (e.g., a touch screen) of the computing device 100 may be exposed to the ambient air 150. In one example, a user of the computing device 100 may hold the computing device 100 by the sides 104 and/or back (not shown) of the computing device 100 with the user's fingers and/or hand such that the screen 105 of the computing device 100 is exposed to and/or surrounded by the ambient air 150.

In one aspect, the computing device 100 may include a help menu with instructions for calibrating the computing device 100 in the first configuration 300. In one example, the computing device 100 may be calibrated in the first configuration 300 by a user of the computing device 100 selecting a configuration (e.g., air only) on a drop-down menu of the computing device 100. After the user selects the configuration 300, instructions may be displayed to the user for proceeding with calibration. For the first configuration 300, the user may be instructed to hold the computing device 100 in the ambient air 150 with the user's fingers and/or hand minimally touching the computing device 100 for some period of time. In one aspect, the period of time may be between one second and two hours. In one example, it may take about two minutes to calibrate the computing device 100. In another example, it may take about three minutes to calibrate the computing device 100. In yet another example, it may take about four minutes to calibrate the computing device 100. In yet another example, it may take about five minutes to calibrate the computing device 100. In one aspect, any amount of time between one second and two hours may be sufficient to calibrate the computing device 100.

While the computing device 100 is calibrated in the first configuration 300, the computing device 100 may measure the plurality of data quantities associated with a rate of change in temperature of the computing device 100. The plurality of data quantities may be measured using at least one sensor of the computing device 100. In some aspects, the plurality of data quantities may be measured using a plurality of sensors at one location and/or at various locations in the computing device 100. For example, there may be a plurality of battery temperature sensors in the computing device 100 that may be used to measure the plurality of data quantities. In another example, the plurality of sensors in the computing device 100 that may be used to measure the plurality of data quantities may include at least one of a linear accelerometer, an orientation sensor, a light/lumen sensor, a voltage/current sensor, a screen brightness sensor, a pressure sensor, a humidity sensor, and the like.

In some embodiments, measuring the plurality of data quantities may be used to determine a rate of change in temperature of the computing device 100. In this regard, a simplified equation for evaluating the plurality of data quantities associated with the rate of change in temperature of the computing device 100 may be achieved. For example, in the first configuration 300, the plurality of data quantities associated with the rate of change in the temperature of the skin of a user can be ignored as the computing device 100 is completely surrounded by ambient air 150 and does not interface with the skin of the user. In turn, the plurality of data quantities associated with the rate of change in temperature of the computing device 100 that include the skin of the user may be ignored. For example, the temperature of the skin of a user (Tₛₖᵢₙ), the area of the screen 105 of the computing device 100 that is surrounded by the skin of a user (Aₛₖᵢₙ^{scr}), the rate of change in temperature between the skin of a user and the screen 105 of the computing device 100 (k_{skindev}^{scr}), the area of the back of the computing device 100 that is surrounded by the skin of a user (Aₛₖᵢₙ^{back}), and the rate of change in temperature between the skin of a user and the back of the computing device 100 (k_{skindev}^{back}) may be ignored. In turn, fewer data quantities need to be determined in order to solve for the rate of change in temperature of the computing device 100.

To further simplify the solution for evaluating the plurality of data quantities associated with the rate of change in temperature of the computing device 100, the remaining data quantities may be assigned to parameters of the model. For example, the area of the screen 105 of the computing device 100 that is surrounded by the ambient air 150 and the area of the back of the computing device 100 that is surrounded by the ambient air 150 may be approximately and/or substantially equal for computing device 100. As such, the area related data quantities can be reduced to a single constant representing area (A) (e.g., the area of one face of the device).

In another example, the rate of change in temperature between the ambient air 150 and the back of the computing device 100 (k_{ambdev}^{back}) and the rate of change in temperature between the ambient air 150 and the screen 105 of the computing device 100 (k_{ambdev}^{scr}) may be added together and fit to a single thermal flux rate (k_{ambdev}).

In yet another example, the area data quantity (A) may be combined with the single thermal flux rate (k_{ambdev}) to a single flux rate proportionality constant of the model (c_{ambdev}). The flux rate proportionality constant (c_{ambdev}) may be linearly proportional to the temperature of the computing device 100. In one aspect, the instructions for calibrating the computing device 100 in the first configuration 300 may indicate that the calibration should proceed under conditions of low light, where the orientation of screen 105 is not normal to the light, and with the screen 105 of the computing device 100 turned off. In one example, the normal lumens to the screen 105 are less than 1000 lux. As such, in this aspect, the rate of heat produced by the screen 105 of the computing device 100 and the rate of radiative heat absorbed by the computing device 100 when the computing device 100 is exposed to light may be assumed to be zero. As such, these data quantities can be ignored in the first configuration 300.

In another aspect, the rate of heat produced by the screen 105 of the computing device 100 may be estimated by the measured rate of change in temperature between the ambient air 150 and the screen 105 of the computing device 100 (k_{ambdev}^{scr}). In another aspect, the screen 105 of the computing device 100 may be dimmed or turned on. In one example, the rate of radiative heat absorbed by the computing device 100 when the computing device 100 is exposed to light may be a constant that can be combined with the other heat source data quantities such that all the heat source data quantities are fit as a single constant (K_{devph}). In another example, the rate of radiative heat emitted by the screen of the computing device 100 may be determined by using a piecewise function of the screen on and off state and the screen brightness that is proportional to the heat source.

After reducing the data quantities, the solution of the model for the first configuration 300 (e.g., the device in contact only with ambient air) may be reduced to four parameters, including both constants and variables. For example, an equation representing the rate of change in temperature of the computing device 100 (T_{dev}) may be a function of four parameters. In one case, the four parameters include the flux rate proportionality constant (c_{ambdev}), an initial ambient air temperature (T_{amb}(0)), the rate of heat produced by the CPU of the computing device 100 (K_{devcpu}), and an initial condition for the temperature of the computing device 100 (T_{dev}(0)). The flux rate proportionality constant (c_{ambdev}) is determined as discussed-above in relation to combining data quantities. The ambient air temperature (T_{amb}) is a constant that is known during calibration by either user input or measurement (as discussed above). The heat produced by the CPU of the computing device 100 (K_{devcpu}) may be calculated by using a function that relates CPU frequency and CPU utilization to the rate of heat the CPU produces. The initial condition for the temperature of the computing device 100 (T_{dev}(0)) may be measured. In one example, the initial condition for the temperature of the computing device 100 (T_{dev}(0)) is the temperature of the computing device 100 at time equal to zero.

As discussed above, the temperature of the computing device 100 may be measured over time as the plurality of data quantities are measured during calibration. In this regard, the temperature of the computing device 100 may be recorded any number of times per second over the time period of the computing device 100 calibrating. In one example, the temperature of the computing device 100 may be recorded four times per second. As such, when the computing device 100 is done measuring the plurality of data quantities during calibration, the solution of the model (or equation) for the first configuration 300 may be plotted and compared with the recorded temperature data of the computing device 100 to determine a difference between the solution of the model for the first configuration 300 and the recorded temperature data of the computing device 100.

Once a difference between the solution of the model for the first configuration 300 and the recorded temperature data of the computing device 100 is determined, one or more of the parameters of the model may be fit and/or adjusted such that the difference between the solution of the model for the first configuration 300 and the recorded temperature data of the computing device 100 is minimized. For example, one or more constants of the model may be adjusted such that the difference between the solution of the model for the first configuration 300 and the recorded temperature data of the computing device 100 is minimized, i.e., the solution of the model and the recorded temperature data are as similar as possible. In one example, fitting the one or more parameters of the model may include performing regression analysis. In another example, fitting the one or more parameters of the model may include performing non-linear regression analysis. In one aspect, the flux rate proportionality constant (c_{ambdev}) and a constant in the function that relates CPU frequency and CPU utilization to the rate of heat the CPU produces are the constants of the model that are adjusted. After the constants that minimize the difference between the solution of the model for the first configuration 300 and the recorded temperature data of the computing device 100 are determined, calibration of the computing device 100 for the first configuration 300 is completed.

When calibration has been completed for the computing device 100, and the model has been fitted to empirical data, the computing device 100 may measure an external temperature of a substance and/or material. In one example, when the calibration has been completed for the first configuration 300, the computing device 100 may measure the external temperature of ambient air. In other examples, the computing device 100 may measure the external temperature of a plurality of substances, as will be discussed in detail below. The external temperature of the ambient air may be measured by finding the value of the ambient air temperature (T_{amb}) that minimizes the difference between the solution of the model for the first configuration 300 and the recorded temperature data of the computing device 100. In this regard, when a user of the computing device 100 desires to measure the ambient air temperature (T_{amb}) using the computing device 100, the solution of the model for the first configuration 300 may be executed. Executing the solution of the model for the first configuration 300 may include comparing the solution of the model for the first configuration 300 with the recorded computer device 100 temperature data to determine a difference between the data and finding the value of the ambient air temperature (T_{amb}) that minimizes the difference between the data. The value of the ambient air temperature (T_{amb}) that minimizes the difference between the data is the measured external temperature.

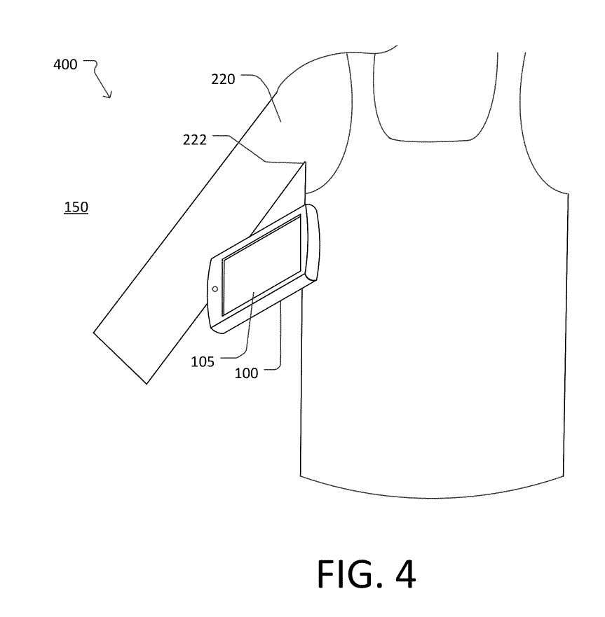

FIG. 4 illustrates embodiments of a second configuration 400 for measuring the external temperature using the computing device 100. The second configuration 400 may include the computing device 100 exposed to and surrounded by the skin 220 of a user of the computing device 100. In this regard, the screen 105 of the computing device 100 may be surrounded by the skin 220 of the user and the back of the computing device 100 may be surrounded by the skin 220 of the user. In one example, a user of the computing device 100 may hold the computing device 100 underneath his or her armpit 222 such that the screen 105 of the computing device 100 and the back of the computing device 100 are surrounded by skin 220.

As discussed above, while the model for measuring the external temperature of a substance and/or material is based on the four compartments and their corresponding connections and boundaries, the model may include a plurality of configurations. Each configuration of the plurality of configurations may facilitate a simplified solution for solving for both the rate of change in temperature of the computing device 100 (T_{dev}) and the rate of change in temperature of the skin of a user (Tₛₖᵢₙ). For example, as illustrated in FIG. 4, the second configuration 400 of the model includes the computing device 100 surrounded by skin 220. In one case, the computing device 100 may be calibrated in the second configuration 400. In one aspect, the computing device 100 may include a help menu with instructions for calibrating the computing device 100 in the second configuration 400. In one example, the computing device 100 may be calibrated in the second configuration 400 by a user of the computing device 100 selecting a configuration (e.g., skin only) on a drop-down menu of the computing device 100. After the user selects the configuration, the user may be instructed on what do to with the computing device 100 for proceeding with calibration. For the second configuration 400, the user may be instructed to hold the computing device 100 in such a way that the computing device 100 is surrounded by skin. As discussed above, the instruction may include holding the computing device 100 in the user's armpit 222. In other examples, the instruction may include holding the computing device 100 between the user's hands or in any other configuration that includes the computing device 100 being surrounded by the user's skin. As discussed above, any amount of time between about one second and about two hours may be sufficient to calibrate the computing device 100.

While the computing device 100 is calibrated in the second configuration 400, the computing device 100 may measure the plurality of data quantities associated with the rate of change in temperature of the computing device 100 (T_{dev}) and the plurality of data quantities associated with the rate of change in temperature of the user's skin 220 (Tₛₖᵢₙ). As discussed above, the plurality of data quantities may be measured using at least one sensor of the computing device 100. In one example, this may include measuring the rate of change in temperature of the computing device 100 (T_{dev}) while measuring the plurality of data quantities associated with the change in temperature of the computing device 100. In another example, this may include measuring the rate of change in temperature of the user's skin 220 (Tₛₖᵢₙ) while measuring the plurality of data quantities associated with the change in temperature of the user's skin 220. In this regard, a simplified solution for evaluating the plurality of data quantities associated with both the rate of change in temperature of the computing device 100 (T_{dev}) and the rate of change in temperature of the user's skin (Tₛₖᵢₙ) may be achieved.

In the second configuration 400, the plurality of data quantities associated with the computing device 100 surrounded by ambient air can be ignored as the computing device 100 is only surrounded by the skin 220 of the user. For example, the area of the screen 105 of the computing device 100 that is surrounded by ambient air (A_{amb}_{_{—}}_{scr}), the rate of change in temperature between ambient air and the screen 105 of the computing device 100 (k_{amb}_{_{—}}_{scr}), the area of the back of the computing device 100 that is surrounded ambient air (A_{amb}_{_{—}}_{back}), and the rate of change in temperature between ambient air and the back of the computing device 100 (k_{amb}_{_{—}}_{back}) may be ignored. In turn, less data quantities have to be evaluated to solve for both the rate of change in temperature of the computing device 100 (T_{dev}) and the rate of change in temperature of the user's skin 220 (Tₛₖᵢₙ).

To further simplify the solution for evaluating the plurality of data quantities associated with the rate of change in temperature of the computing device 100 (T_{dev}) and the rate of change in temperature of the user's skin 220 (Tₛₖᵢₙ), the remaining data quantities may be assigned to parameters of the model, similar to the first configuration 300, as discussed above. For example, the area of the screen 105 of the computing device 100 that is surrounded by the skin 220 of the user (Aₛₖᵢₙ_{_{—}}_{scr}) and the area of the back of the computing device 100 that is surrounded by skin 220 of the user (Aₛₖᵢₙ_{_{—}}_{back}) may be approximately and/or substantially equal in the computing device 100. As such, the area related data quantities can be reduced to one area data quantity (A) (e.g., the area of one face of the device). In another example, the rate of change in temperature between the user's skin 220 and the back of the computing device 100 (kₛₖᵢₙ_{_{—}}_{back}) and the rate of change in temperature between the user's skin 220 and the screen 105 of the computing device 100 (kₛₖᵢₙ_{_{—}}_{scr}) may be added together and fit to a single thermal flux rate (k_{ambdev}).

In yet another example, the area data quantity (A) may be combined with the single thermal flux rate (k_{ambdev}) to a first flux rate proportionality constant of the model (r_{skindev}). In still another example, the area of the skin of a user that is touching the computing device 100 (Aₛₖᵢₙ), and the rate of change in temperature between the skin 220 of a user and the ambient air 150 (k_{skinamb}) may be combined to a second flux rate proportionality constant of the model (r_{ambskin}). In one case, the second flux rate proportionality constant (r_{ambskin}) may vary based on the size of the user. In still another example, the area of the skin of a user that is touching the computing device 100 (Aₛₖᵢₙ) and the rate of change in temperate between the skin 220 of a user and the core body of the user (k_{skincore}) may be combined to a third flux rate proportionality constant of the model (r_{skincore}).

As discussed above relative to the first configuration 300, the instructions for calibrating the computing device 100 may indicate that the calibration should proceed under conditions of low light. This may also apply with the second configuration 400. As such, the rate of radiative heat absorbed by the skin 220 of a user when the skin 220 of the user is exposed to light may be assumed to be zero (e.g., the user's skin 220 is under conditions of low light). As such, this data quantity may be ignored in the second configuration 400.

After reducing the data quantities, the solution of the model for the second configuration 400 may be reduced to eight parameters. For example, solving for the rate of change in temperature of the computing device 100 (T_{dev}) and the rate of change in temperature of the user's skin 220 (Tₛₖᵢₙ) may include a solution (e.g., an equation) with eight parameters.

In one case, the eight parameters include the three flux rate proportionality constants (r_{skindev}, r_{ambskin}, r_{skincore}), the ambient air temperature (T_{amb}), the rate of heat produced by the CPU of the computing device 100 (K_{devcpu}), an initial condition for the temperature of the computing device 100 (T_{dev}(0)), the core body temperature (T_{core}), and an initial condition of the user's skin 220 temperature (Tₛₖᵢₙ(0)). In one case, the second flux rate proportionality constant (r_{ambskin}) and third flux rate proportionality constant (r_{skincore}) may be approximated from skin tissue studies. For example, the second flux rate proportionality constant (r_{ambskin}) and third flux rate proportionality constant (r_{skincore}) may vary based on the area of a user's surface and the composition of the user. In one example, the thermal flux rate of a water-to-water interface and water-to-air interface may be used as an estimate for the second flux rate proportionality constant (r_{ambskin}) and third flux rate proportionality constant (r_{skincore}).

As discussed above in relation to the first configuration 300, the ambient air temperature (T_{amb}) is a constant that is known during calibration by either user input or measurement (as discussed above). The heat produced by the CPU of the computing device 100 (K_{devcpu}) may be calculated by using a function that relates CPU frequency and CPU utilization to the rate of heat the CPU produces. In one example, if the first configuration 300 is calibrated before the second configuration 400, the ambient air temperature (T_{amb}) and the heat produced by the CPU of the computing device 100 (K_{devcpu}) are known from the calibration of the first configuration 300.

The core body temperature (T_{core}) is a known constant unless the user has a fever, for example. The initial condition for the temperature of the computing device 100 (T_{dev}(0)) may be measured, as discussed above in relation to the first configuration 300. In one example, the initial condition for the temperature of the computing device 100 (T_{dev}(0)) is the temperature of the computing device 100 at time equal to zero. The initial condition of the temperature of the user's skin 220 (Tₛₖᵢₙ(0)) may be determined using an external thermometer during calibration. The first flux rate proportionality constant (r_{skindev}) may be fit and/or adjusted such that the difference between the solution of the model for the second configuration 400 and the recorded temperature data of the computing device 100 and the user's skin 220 is minimized.

As discussed above, the rate of change in temperature of the computing device 100 (T_{dev}) and the rate of change in temperature of the user's skin 220 (Tₛₖᵢₙ) may be measured over time as the plurality of data quantities are measured during calibration. In this regard, the temperature of the computing device 100 and the temperature of the user's skin 220 may be recorded any number of times per second over the time period of the computing device 100 calibrating. In one case, the temperature of the computing device 100 and the temperature of the user's skin 220 may be recorded four times per second. As such, when the computing device 100 is done measuring the plurality of data quantities during calibration, the solution of the model for the second configuration 400 may be compared with the recorded temperature data of the computing device 100 and the recorded temperature data of the user's skin 220 to determine a difference between the solution of the model for the second configuration 400 and the recorded temperature data of the computing device 100 and the user's skin 220.

In one case, the solution of the model for the second configuration 400 may include a device solution and a skin solution. For example, the device solution of the model may be compared with the recorded temperature data of the computing device 100 to determine a difference between the device solution of the model and the recorded temperature data of the computing device 100. In another example, the skin solution of the model may be compared with the recorded temperature data of the user's skin 220 to determine the difference between the skin solution of the model and the recorded temperature data of the user's skin 220.

Once a difference between the solution of the model for the second configuration 400 and the recorded temperature data of the computing device 100 and the user's skin 220 is determined, one or more of the parameters of the model may be fit and/or adjusted such that the difference between the solution of the model for the second configuration 400 and the recorded temperature data of the computing device 100 and the user's skin 220 is minimized. For example, one or more constants of the model may be adjusted such that the difference between the solution of the model for the second configuration 400 and the recorded temperature data of the computing device 100 and the user's skin 220 is minimized, i.e., the solution of the model and the recorded temperature data are as similar as possible. In one aspect, the first flux rate proportionality constant (r_{skindev}) is the constant of the model that is adjusted. After the constants that minimize the difference between the solution of the model for the second configuration 400 and the recorded temperature data of the computing device 100 and the user's skin 220 are determined, calibration of the computing device 100 for the second configuration 400 is completed.

As discussed above, when calibration has been completed for the computing device 100 and the model has been fitted to empirical data, the computing device 100 may measure an external temperature of a substance and/or material. In one example, when the calibration has been completed for the second configuration 400, the computing device 100 may measure the external temperature of a person's skin and a person's core body temperature. In other examples, the computing device 100 may measure the external temperature of a plurality of substances. The external temperature of the person's skin and the person's core body may be measured by finding the value of the temperature of the person's skin and the person's core body that minimizes the difference between the solution of the model for the second configuration 400 and the recorded temperature data of the computing device 100 and the user's skin 220.

In this regard, when a user of the computing device 100 desires to measure a person's skin or core body temperature using the computing device 100, the solution of the model for the second configuration 400 may be executed. Executing the solution of the model for the second configuration 400 may include comparing the solution of the model for the second configuration 400 with the recorded temperature data of the computer device 100 and the recorded temperature data of the user's skin 220 to determine a difference between the data. Executing the solution of the model for the second configuration 400 may further include finding the value of the skin temperature and core body temperature that minimizes the difference between the data. In a first example, if a user desires to measure a person's skin temperature, the device solution (e.g., equation) of the solution of the model for the second configuration 400 may be executed such that the device solution of the model is compared with recorded temperature data of the computing device 100 to determine a difference between the device solution of the model and the recorded temperature data of the computing device 100. After the difference between the data is determined, the value of the skin temperature that minimizes the difference between the device solution of the model and the recorded temperature data of the computing device 100 is found.

Additionally, the skin solution (e.g., equation) of the solution of the model for the second configuration 400 may be executed such that the skin solution of the model is compared with recorded temperature data of the user's skin 220 to determine a difference between the skin solution of the model and the recorded temperature data of the user's skin 220. After the difference between the data is determined, the value of the skin temperature that minimizes the difference between the skin solution of the model and the recorded temperature data of the user's skin 220 is found. The value of the skin temperature that minimizes the difference between both solutions of the model and the recorded temperature data for both the computing device 100 and the user's skin 220 is the measured skin temperature.

In another example, if a user desires to measure a person's core body temperature, the device solution of the solution of the model for the second configuration 400 may be executed such that the device solution of the model is compared with recorded temperature data of the computing device 100 to determine a difference between the device solution of the model and the recorded temperature data of the computing device 100. After the difference between the data is determined, the value of the core body temperature that minimizes the difference between the device solution of the model and the recorded temperature data of the computing device 100 is found.

Additionally, the skin solution of the solution of the model for the second configuration 400 may be executed such that the skin solution of the model is compared with recorded temperature data of the user's skin 220 to determine a difference between the skin solution of the model and the recorded temperature data of the user's skin 220. After the difference between the data is determined, the value of the core body temperature that minimizes the difference between the skin solution of the model and the recorded temperature data of the user's skin 220 is found. The value of the core body temperature that minimizes the difference between both solutions of the model and the recorded temperature data for both the computing device 100 and the user's skin 220 is the measured core body temperature.

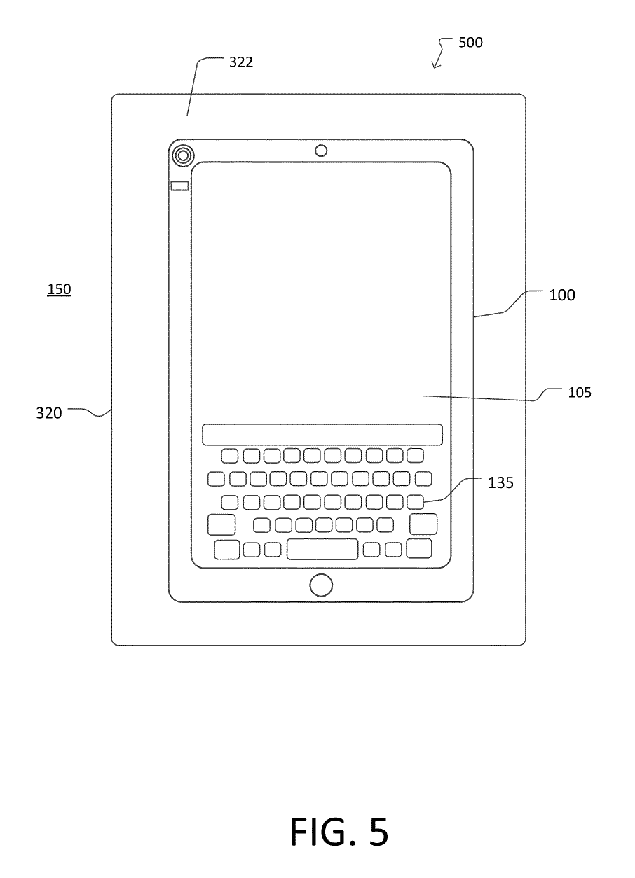

FIG. 5 illustrates embodiments of a third configuration 500 for measuring the external temperature using the computing device 100. The third configuration 500 may include the computing device 100 exposed to the ambient air 150 on one side and exposed to the skin 320 of a user of the computing device 100. In one example, the screen 105 of the computing device 100 may be exposed to the ambient air 150 and the back of the computing device 100 may be exposed to and surrounded by a stomach 322 of the skin 320 of a user. In this regard, a user of the computing device 100 may hold the computing device 100 against their stomach 322 such that the screen 105 of the computing device 100 is exposed to the ambient air 150 and the back of the computing device 100 is surrounded by the user's skin 320. In another example, a user of the computing device 100 may hold the computing device 100 against their stomach 322 such that the screen 105 of the computing device 100 is surrounded by the user's skin 320 and the back of the computing device 100 is exposed to the ambient air 150.

In one case, the user may utilize the third configuration 500 for measuring an external temperature of a substance (e.g., the ambient air temperature (T_{amb}), a person's skin temperature (Tₛₖᵢₙ), and a person's core body temperature (T_{core}), to name a few) after the computing device 100 has been calibrated in the first configuration 300 and the second configuration 400. As discussed above, the external temperature of the ambient air (T_{amb}), a person's skin (Tₛₖᵢₙ) and a person's core body (T_{core}) may be measured by finding the value of the temperature of the ambient air, the person's skin and the person's core body that minimizes the difference between the solution of the model for the first configuration 300 and the solution of the model for the second configuration 400 and the recorded temperature data of the computing device 100 in the first configuration 300 and the recorded temperature data of the computing device 100 and the user's skin 220 in the second configuration 400.

In this regard, when a user of the computing device 100 desires to measure the ambient air temperature (T_{amb}) using the computing device 100 in the third configuration 500, the solution of the model for the first configuration 300 may be executed as discussed above. When a user of the computing device 100 desires to measure a person's skin or core body temperature using the computing device 100 in the third configuration 500, the solution of the model for the second configuration 400 may be executed as discussed above.

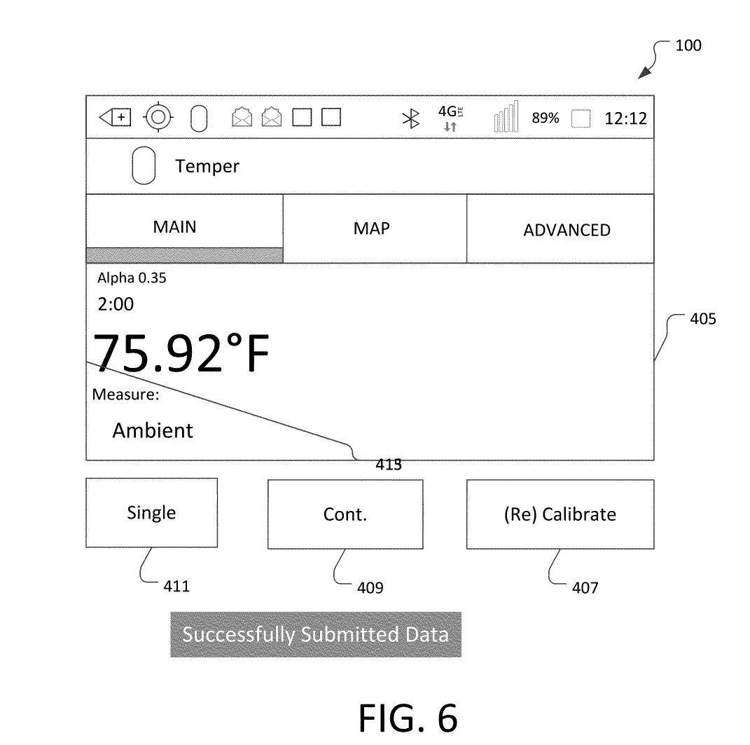

FIG. 6 illustrates embodiments of a user interface 405 of the computing device 100. The user interface 405 may include a calibration button 407, a continuation button 409, a single button 411, the measured temperature 413, and the type of temperature (e.g., the substance and/or material) measured 415. In the exemplary embodiment of FIG. 6, the type of temperature measured 415 is the ambient temperature and the measured temperature 413 is 75.92° F. The calibration button 407 may be used to calibrate the computing device 100, as discussed above.

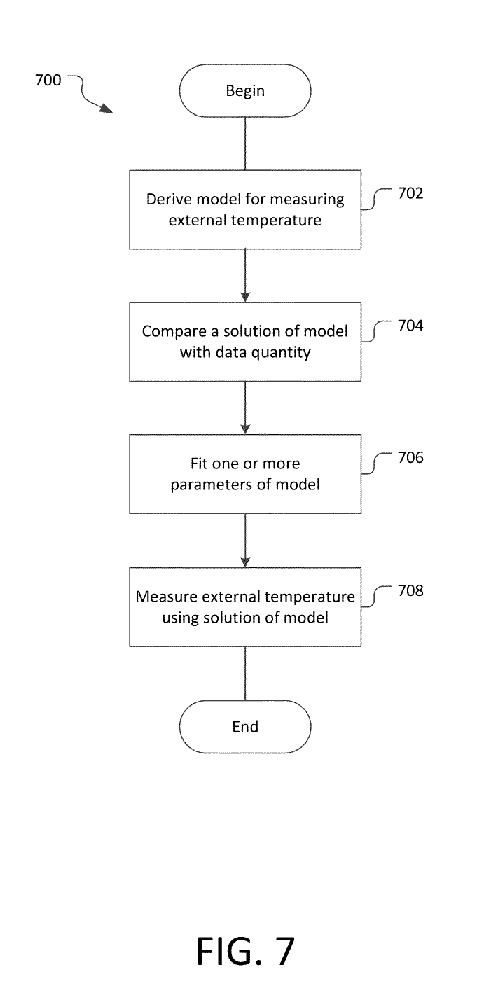

Referring now to FIG. 7, an exemplary method 700 for measuring an external temperature using a computing device, according to an example aspect is shown. Method 700 may begin at operation 702, where a model is derived for measuring the external temperature. The external temperature of any substance and/or material may be measured. In one example, a substance may include any species of matter such as air, water, blood, tissue, metal, wood, plastic, mineral, and the like. In one example, a material may include a mixture of substances and/or any composition of materials. In this case, an external temperature may be measured for the ambient air, the skin of a person, the core body of a person, the surface of any object, and the like. Deriving the model for measuring the external temperature may include identifying a plurality of temperature compartments, identifying one or more boundaries between one or more of the plurality of temperature compartments, placing the computing device into a configuration that limits a number of boundaries and temperature compartments, measuring a plurality of data quantities using at least one sensor of the computing device and determining parameters of the model using the plurality of data quantities such that the parameters of the model are minimized. In some cases, the parameters of the model may include at least some of the plurality of data quantities. In one case, deriving the model for measuring the external temperature may be done while calibrating the computing device.

After the model for measuring the external temperature has been derived, flow proceeds to operation 704 where a solution of the model is compared with at least one of the plurality of data quantities. In one case, the solution of the model may be compared with at least one of the plurality of data quantities to determine a difference between the solution of the model and the at least one of the plurality of data quantities. In a first configuration, the at least one of the plurality of data quantities compared to the solution of the model may be a temperature of the computing device as a function of time. In a second configuration, the at least one of the plurality of data quantities compared to the solution of the model may be a temperature of skin of a user as a function of time. In this regard, the solution of the model may be compared to recorded device and skin temperature data that has been measured over a period of time.

After the solution of the model is compared with at least one of the plurality of data quantities, flow proceeds to operation 706 where one or more of the parameters of the model may be fit such that the difference between the solution of the model and the at least one of the plurality of data quantities is minimized. For example, one or more constants of the model may be adjusted such that the difference between the solution of the model and the at least one of the plurality of data quantities is minimized, i.e., the solution of the model and the at least one of the plurality of data quantities are as similar as possible. In one example, fitting the one or more parameters of the model may include performing regression analysis. In other example, fitting the one or more parameters of the model may include performing non-linear regression analysis.

After one or more of the parameters of the model are fit such that the difference between the solution of the model and the at least one of the plurality of data quantities is minimized, flow proceeds to operation 708 where the external temperature using the solution of the model may be measured. In one case, the external temperature may be measured after the computing device has been calibrated. Measuring the external temperature may include finding a value of a parameter of the model that corresponds to the external temperature that minimizes the difference between the solution of the model and the at least one of the plurality of data quantities. The parameter of the model that corresponds to the external temperature may include at least one of an ambient air temperature, a temperature of skin of a user, and a core body temperature. In this regard, the external temperature is measured by utilizing components of the computing device and associated measured and/or calculated data quantities.

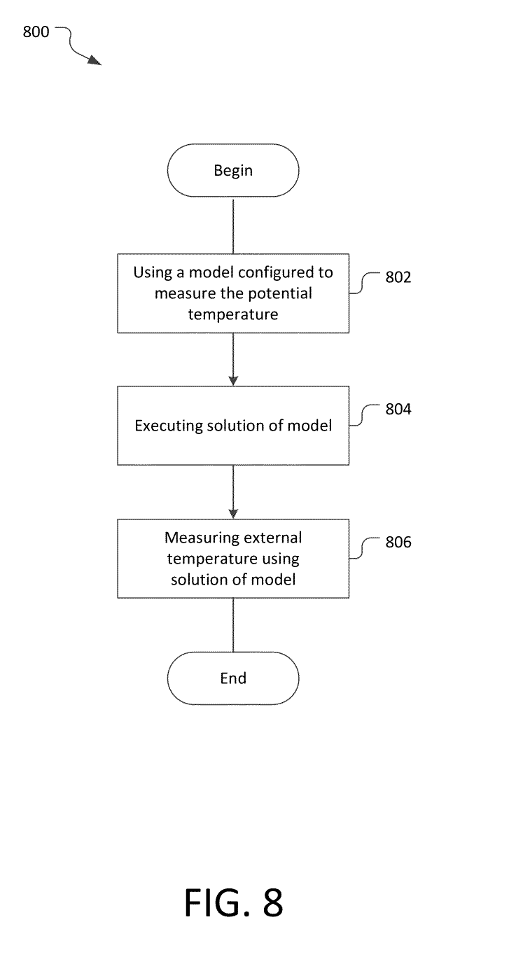

Referring now to FIG. 8, an exemplary method 800 for measuring an external temperature using a computing device, according to an example aspect is shown. Method 800 may begin at operation 802, where a model configured to measure the external temperature is used. For example, the model configured to measure the external temperature may be derived while calibrating the computing device. Additionally, the model may include a solution that is derived from calibrating the computing device. The solution of the model may be based on a configuration. For example, when the computing device is calibrated in a first configuration, the solution of the model may include a first set of parameters. In another example, when the computing device is calibrated in a second configuration, the solution of the model may include a second set of parameters. In one case, the first and second set of parameters may have at least some parameters that are the same.

At operation 804, the solution of the model may be executed. Executing the solution of the model may include comparing the solution of the model with recorded temperature data, determining a difference between the solution of the model and the recorded temperature data, and fitting a parameter of the model that corresponds to the external temperature such that the difference between the solution of the model and the recorded temperature data is minimized. In one case, the recorded temperature data may include the temperature of the computing device as a function of time. In another case, the recorded temperature data may include the temperature of skin of a user as a function of time. The parameter of the model that corresponds to the external temperature may include at least one of an ambient air temperature, a temperature of skin of a user, and a core body temperature.

After the solution of the model is executed, flow proceeds to operation 806 where the external temperature using the solution of the model may be measured. In one case, the external temperature may be measured after the computing device has been calibrated. Measuring the external temperature may include finding a value of a parameter of the model that corresponds to the external temperature that minimizes the difference between the solution of the model and the recorded temperature data. In this regard, the external temperature is measured by utilizing components of the computing device and associated measured and/or calculated data quantities.

Methods 700 and 800 may be implemented on a computing device or a similar electronic device capable of executing instructions through at least one processor. The computing device may be any suitable computing device for executing a temperature measuring application. Any suitable computing device may be utilized by methods 700 and 800 for executing the temperature measuring application and measuring an external temperature. For example, the computing device may be at least one of: a mobile telephone; a smart phone; a tablet; a smart watch; a wearable computer; a personal computer; a desktop computer; a laptop computer; and etc. This list is exemplary only and should not be considered as limiting. Any suitable computing device for executing the temperature measuring application of the present application may be utilized by methods 600 and 700.

As discussed above, calibration may be done by a user using the computing device 100. It is appreciated that the calibration of the computing device 100 may be done in any way and any place suitable to calibrate the computing device 100. In one case, the calibration may be done at a manufacturing facility, for example, before the computing device 100 is given to a user. In another example, the temperature measuring application may be calibrated such that when a user downloads the temperature measuring application on the computing device 100, the computing device 100 is calibrated. In some cases, when a first user of the computing device 100 calibrates the computing device 100, all computing devices of the same model number may automatically be calibrated without any further action from users of the computing devices of the same model number. For example, if a user of a Galaxy S5 mobile phone downloads the temperature measuring application on the Galaxy S5 and calibrates the Galaxy S5 according to instructions, all users of Galaxy S5's of the same model number who download the temperature measuring application will automatically have their Galaxy S5 calibrated.

The plurality of data quantities used for determining parameters of the model, as discussed herein, may vary based on a computing device type, model, material, and the like. For example, the geometry and composition of the computing device may result in different area and thermal flux rates for different device models. In some cases, the parameters of the solution of the model may vary based on the computing device type, model, material, and the like. In this regard, calibration may be required for each computing device model number.

In some aspects, the data quantities that are measured may be uploaded to a database and/or server for storage. The data quantities stored in the database and/or server may be analyzed such that parameters of the model may be determined by computing device model number. For example, different computing device geometries may be analyzed to determine the area data quantities by device model number.

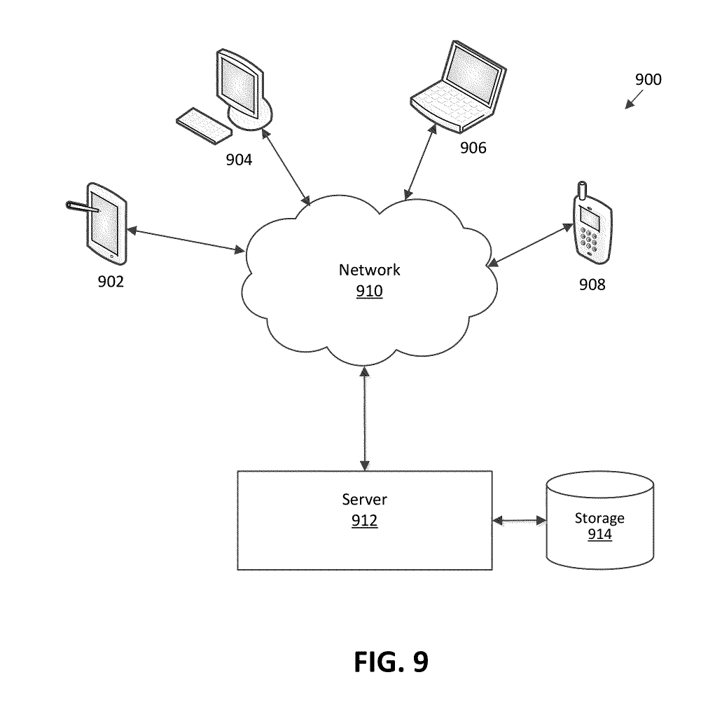

FIG. 9 illustrates a system for measuring an external temperature. The system 900 includes a first client 902, a second client 904, a third client 906, and a fourth client 908. Although four clients are shown, it is contemplated that fewer or additional clients may access the server 912 through the network connection 910. In some embodiments, one or more of clients 902-908 are computing devices capable of executing a temperature measurement application, as described with reference to FIGS. 1-8 above. In other embodiments, one or more of clients 902-908 are capable of measuring an external temperature by communicating with one or more of clients 902-908 via the network connection 910. In still other embodiments, clients 902-908 are capable of measuring an external temperature by communicating with server 912 via a web browser over network connection 910. In some embodiments, one or more servers 912 may be used to implement aspects of the disclosure.

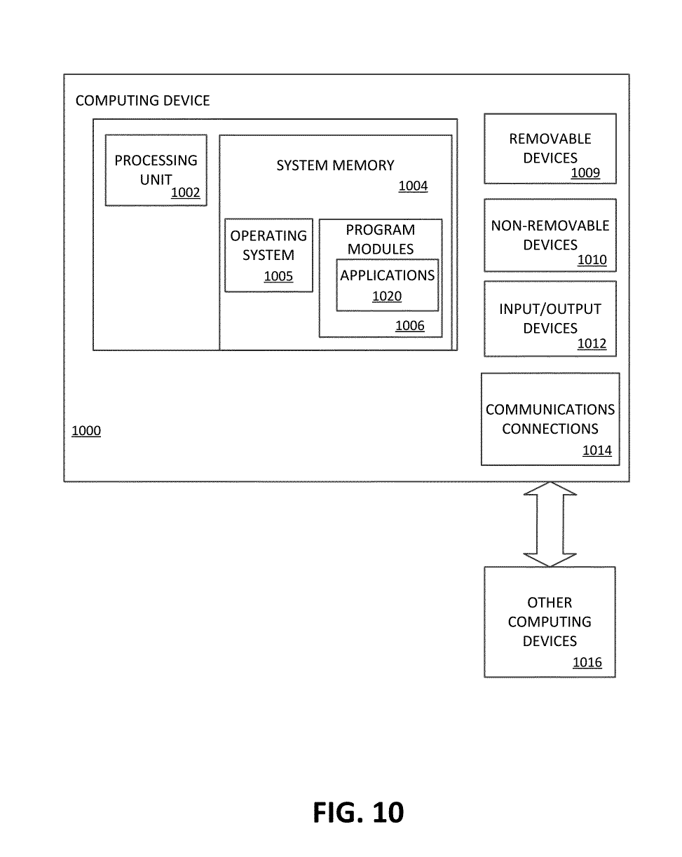

FIG. 10 is a block diagram illustrating physical components (i.e., hardware) of a computing device with which embodiments of the disclosure may be practiced.

The computing device components described below may be suitable for the computing devices described above. In general, the computing device 1000 may include at least one processing unit 1002 and a system memory 1004. In embodiments, the system memory 1004 may comprise, but is not limited to, volatile storage (e.g., random access memory, RAM), non-volatile storage (e.g., read-only memory, ROM), flash memory, or any combination thereof. The system memory 1004 may include an operating system 1005 and one or more program modules 1006 that are suitable for running software applications 1020 such as a temperature measurement application. The operating system 1005, for example, may be suitable for controlling the operation of the computing device 1000 in order to display or present content. In other embodiments, computing system 1000 may not have or require a traditional operating system (e.g., an FPGA). Furthermore, embodiments may be practiced in conjunction with one or more libraries (e.g., a graphics library), other operating systems, or any other application program and is not limited to any particular application or system.

In embodiments, the computing device 1000 may additionally include data storage devices (e.g., removable devices 1009 and/or non-removable devices 1010) such as, for example, magnetic disks, optical disks, or tape.

As stated above, a number of program modules and data files may be stored in the system memory 1004. While executing on the processing unit 1002, the program modules 1006 (e.g., including a temperature monitoring application) may perform processes including, but not limited to, one or more of the stages of the methods 800-900 illustrated in FIGS. 7-8.

Furthermore, embodiments may be practiced in an electrical circuit comprising discrete electronic elements, packaged or integrated electronic chips containing logic gates, a circuit utilizing a microprocessor, a FPGA, or on a single chip containing electronic elements or microprocessors. For example, field programmable gate arrays (FPGAs) are semiconductor devices based on a matrix of configurable logic blocks (CLBs) connected by a hierarchy of programmable/reconfigurable interconnects that allow for complex computations without traditional operating systems. FPGAs can be reprogrammed to desired application or functionality requirements after manufacturing. When embodiments are practiced using a FPGA, the functionality described herein may be implemented using programmable logic executing within a matrix of CLBs. In another example, embodiments may be practiced via a system-on-a-chip (SOC) where each or many of the components illustrated in FIG. 10 may be integrated onto a single integrated circuit. When operating via an SOC, functionality may be operated via application-specific logic integrated with other components of the computing device 1000 on the single integrated circuit (chip). In still other embodiments, other technologies capable of performing logical operations may be employed, such as, for example, mechanical, optical, fluidic, and quantum technologies. In addition, embodiments may be practiced within a general purpose computer or in any other circuits or systems.

The computing device 1000 may also have one or more input and/or output device(s) 1012 (e.g., a keyboard, a mouse, a pen, a sound input device, a touch input device, a display, speakers, a printer, and the like). In some embodiments, computing device 1000 may further comprise an input/output (I/O) device 1012 such as a touch screen. The computing device 1000 may include one or more communication connections 1014 (e.g., an RF transmitter, receiver, and/or transceiver circuitry, universal serial bus (USB), parallel, and/or serial ports, etc.) allowing communications with other computing devices 1016.

Computer-readable instructions for performing the methods described herein may be executed by computing device 1000, as described above, and/or stored in a computer storage media. Computer storage media may include any volatile or nonvolatile, removable or non-removable media for storage of computer readable instructions, data structures, program modules, applications, etc. The system memory 1004, the removable storage device 1009, and the non-removable storage device 1010 are all computer storage media examples (i.e., memory storage). Computer storage media may further include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated or modulated data signal.

The embodiments and functionalities described herein may operate via a multitude of computing systems including, without limitation, wired and wireless computing systems, mobile computing systems (e.g., mobile telephones, netbooks, tablet or slate type computers, and laptop computers), and the like.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet.

Embodiments of the present disclosure, for example, are described above with reference to block diagrams and/or operational illustrations of methods, systems, and computer program products according to embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the disclosure as claimed in any way. The embodiments, examples, and details provided in this application are considered sufficient to convey possession and enable others to make and use the best mode recited by the claims. The claims should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claims.

What is claimed is:

1. A method for measuring an external temperature using a computing device, the method comprising:
deriving a model for measuring the external temperature, wherein deriving the model comprises:
identifying one or more temperature compartments;
identifying one or more boundaries between the one or more temperature compartments;
placing the computing device into a configuration that limits a number of boundaries and temperature compartments;
measuring a plurality of data quantities using at least one sensor of the computing device; and
determining parameters of the model using the plurality of data quantities such that the parameters of the model are minimized;
comparing a solution of the model with at least one of the plurality of data quantities to determine a difference between the solution of the model and the at least one of the plurality of data quantities;
fitting one or more of the parameters of the model such that the difference between the solution of the model and the at least one of the plurality of data quantities is minimized; and
measuring the external temperature using the solution of the model.

2. The method of claim 1, wherein the model includes one or more of a first configuration, a second configuration, and a third configuration.

3. The method of claim 2, wherein the first configuration comprises the electronic device surrounded by ambient air, wherein the second configuration comprises the electronic device surrounded by skin of a user, and wherein the third configuration comprises the electronic device surrounded by both ambient air and skin of a user.

4. The method of claim 3, wherein the solution of the model is dependent on the configuration of the model.

5. The method of claim 1, wherein the computing device includes a user interface, the user interface including a menu comprising a list of selectable substances, the selectable substances being substances desired to be measured for their temperature.

6. The method of claim 3, wherein the at least one of the plurality of data quantities compared with the model comprises a temperature of the computing device as a function of time.

7. The method of claim 6, wherein the computing device includes a CPU, and wherein the parameters of the model for the first configuration include at least one of a flux rate proportionality constant, an ambient air temperature, an rate of heat produced by the CPU of the computing device, and an initial condition for the temperature of the computing device.

8. The method of claim 7, wherein the at least one of the plurality of data quantities compared with the model comprises a temperature of skin of a user as a function of time.

9. The method of claim 8, wherein the parameters of the model for the second configuration include at least one of a first flux rate proportionality constant, a second flux rate proportionality constant, a third flux rate proportionality constant, the ambient air temperature, a core body temperature, the rate of heat produced by the CPU of the computing device, the initial condition for the temperature of the computing device, and an initial condition for the temperature of skin of a user as a function of time.

10. The method of claim 9, wherein the one or more parameters of the model that are fit for the first configuration include at one of the rate of heat produced by the CPU of the computing device and the flux rate proportionality constant, and wherein the one or more parameters of the model that are fit for the second configuration include at least the first flux rate proportionality constant.

11. The method of claim 1, wherein measuring the external temperature comprises finding a value of a parameter of the model that corresponds to the external temperature that minimizes the difference between the solution of the model and the at least one of the plurality of data quantities.

12. The method of claim 11, wherein the parameter of the model that corresponds to the external temperature includes at least one of an ambient air temperature, a temperature of skin of a user, and a core body temperature.

13. A method for measuring an external temperature using a computing device, the method comprising:
using a model configured to measure the external temperature, wherein a solution of the model is derived from a calibration of the computing device;
executing the solution of the model, wherein executing the solution of the model comprises:
comparing the solution of the model with recorded temperature data;
determining a difference between the solution of the model and the recorded temperature data; and
fitting a parameter of the model that corresponds to the external temperature such that the difference between the solution of the model and the recorded temperature data is minimized; and
measuring the external temperature using the solution of the model.

14. The method of claim 13, wherein the parameter of the model that corresponds to the external temperature includes at least one of an ambient air temperature, a temperature of skin of a user, and a core body temperature.

15. The method of claim 13, wherein the solution of the model is dependent on a configuration of the model.

16. The method of claim 13, wherein the recorded temperature data comprises a temperature of the computing device as a function of time.

17. The method of claim 13, wherein the recorded temperature data comprises a temperature of skin of a user as a function of time.

18. The method of claim 13, wherein measuring the external temperature comprises finding a value of the parameter of the model that corresponds to the external temperature that minimizes the difference between the solution of the model and the recorded temperature data.

19. The method of claim 13, further comprising:
receiving a selection of a button indicating a substance desired to be measured for its temperature, wherein the button is included on a user interface of the computing device.

20. A computer storage device having computer executable instructions that, when executed by a processor, perform a method for measuring an external temperature using a computing device, the method comprising:
using a model configured to measure the external temperature, wherein a solution of the model is derived from a calibration of the computing device;
executing the solution of the model, wherein executing the solution of the model comprises:
comparing the solution of the model with recorded temperature data;
determining a difference between the solution of the model and the recorded temperature data; and
fitting a parameter of the model that corresponds to the external temperature such that the difference between the solution of the model and the recorded temperature data is minimized; and
measuring the external temperature using the solution of the model.
